(19) United States
(12) Patent Application Publication
(10) Pub. No.: US 2011/0180973 A1
(43) Pub. Date: Jul. 28, 2011

(54) Method for Making an Outlet Channel

(76) Inventor: Lianhua MAO, Xiamen (CN)

(21) Appl. No.: 12/859,489

(22) Filed: Aug. 19, 2010

(30) Foreign Application Priority Data
Jan. 26, 2010 (CN) 201010107902

(51) Int. Cl. B29C 49/06

(52) U.S. Cl. 264/504

(57) ABSTRACT

A method for making an outlet channel disposes an air spout on a mold corresponding to an inlet gate or an outlet gate of a shaping cavity of an outlet device. An overflow well is disposed corresponding to the outlet or inlet gates of the outlet device. A plastic material is injected into the shaping cavity until the overflow well is filled. During the hardening happens to a part of the plastic material near the shaping cavity wall, the high-pressure nitrogen or liquid is imparted through the air spout, thereby allowing a certain passage formed with the communicated inlet gate and the outlet gate of a body portion of the outlet device to be structured in the plastic material. The part of the plastic material extruded by the high-pressure nitrogen or liquid enters the overflow well. Cooling the entire mechanism allows the outlet device with a certain-shaped passage to be achieved. Thus, a plastic outlet device with a certain-shaped passage is formed, which renews the traditional forming method to promote the integrity of the injecting product, thereby ensuring the pressure-bearing competence as well as prolonging the using life.

### BACKGROUND OF THE INVENTION

1. Field of the Invention

The present invention relates to a method for making an outlet channel like the faucet or the outlet tap.

2. Description of the Related Art

In view of the rising life level, household supplies are increasingly developed with the high quality and the superior feature. At present, the faucet in the house could be formed by multiple types. Especially, the traditional method for making the faucet generally adopts the metal copper to cast a certain passage therein. However, the price of copper is continuingly increased in the recent years. Moreover, the lead contained in the copper readily pollutes the water quality. Thus, many developed countries regulate that the copper for making the faucet must adopt the brass that is lead-free or contains little lead. As a result, the price of such brass is adversely even higher than the conventional copper.

In order to conquer the high material cost and meet the environmental requirement, some manufacturers adopt the plastic material to make the faucet. Herein, a core-injection could be favorably adopted to form the plastic material into a linear or a regular passage. For forming the inner passage with a certain contour, several segments are to be pieced together (by the ultrasound welding or sliding molding) after they are formed separately; thereby, an outlet device with an inner passage is formed. Wherein, afore inner passage formed by the piecing means should bear a certain degree of water pressure; nevertheless, the piecing force on the segments is in fact unsatisfied. Thus, such piecing means could not assure a long using life of the outlet device.

### SUMMARY OF THE INVENTION

The object of the present invention is to employ a plastic material that meets the food safety regulation (NSF 6.1 standard) and is able to bear 100° C. temperature so as to ensure the using life of an outlet device.

Method for making such outlet channel comprises steps as follows:
1) a shaping cavity being formed in a first mold corresponding to an surface of a body portion of an outlet device; an air spout being disposed in accordance with an inlet gate or an outlet gate of the outlet device; an overflow aperture being disposed corresponding to the inlet or outlet gates, thereby connecting to an overflow well;
2) a non-toxic melted plastic material capable of bearing 100° C. temperature keeping being injected into the shaping cavity of the first mold until the plastic material filling the shaping cavity and reaching the overflow aperture of an end portion;
3) the high-pressure nitrogen or the high-pressure liquid being imparted through the air spout while part of the melted plastic material near the shaping cavity being hardened, thereby permitting a passage with a certain shape to be formed inside the plastic material to communicate with the inlet and outlet gates of the body portion of the outlet device; a part of the plastic material that is extruded by the high-pressure nitrogen or the high-pressure liquid imparting into the overflow well through the overflow aperture on the end portion;
4) the outlet device with the end portion being drawn after the mechanism being cooled and the first mold being opened; and
5) the outlet device with the certain-shaped passage formed thereby being achieved after removing the end portion from the outlet gate of the body portion.

A spiral fixing block installed at a front portion of the body portion of the outlet device after the step 5) is further mounted into a shaping cavity of a second mold, thereby employing a fixing platen and a fixing post to suspend the body portion of the outlet device in the shaping cavity;
6) a melted plastic material that could be readily electroplated or sprayed is injected into the shaping cavity of the second mold until the plastic material fills the shaping cavity, thereby forming a hardened case portion out of the body portion;
7) the body portion wrapped in the plastic material and the spiral fixing block are drawn from the shaping cavity after the second mold is opened;
8) the spiral fixing block and the body portion wrapped in the plastic material are separated so as to ream a passage port on the outlet gate at the front portion of the body portion; and
9) the surface of the case portion of the body portion of the outlet device wrapped in the electroplated or sprayed material is further electroplated or sprayed.

The pressure adopted on the high-pressure nitrogen or the high-pressure liquid adopted in step 3) is 150-3000 Bar.

Method for making an outlet channel including an outlet device adopting an inlet bracket comprises steps of:
1) an H-shaped shaping cavity for the inlet bracket being disposed inside a mold; an overflow aperture and an overflow well being sequentially disposed out of the shaping cavity; each of two sliding devices including a shaping core being respectively disposed at two correspondent sides of the exterior of the mold; the shape of the two shaping cores at a first sliding device being formed into a shape suitable to the contour of an upper aperture in accordance with the inlet bracket; the exterior at a front portion of the two shaping cores respectively forming a prominent platen suitable to the contour of an inlet passage at a lower portion of the upper aperture in accordance with the inlet bracket; an inner front of one of the shaping cores installing an air pin that penetrates the shaping core; the shape of the two shaping cores of a second sliding device being formed into a shape suitable to the contour of a lower aperture in accordance with the inlet bracket; thereby, closing the mold allowing the two sliding devices to correspondingly move toward the mold, thence permitting the two shaping cores respectively to protrude toward a position corresponding to the upper aperture in accordance with the inlet bracket on the shaping cavity; the two shaping cores on the second sliding device respectively protruding toward a position corresponding to the lower aperture in accordance with the inlet bracket on the shaping cavity; a front face of the prominent platen at the front portion of the two shaping cores on the first sliding device respectively propping against a front face of the correspondent shaping core on the second sliding device;
2) a non-toxic melted plastic material capable of bearing 100° C. temperature being injected into the shaping cavity of the mold until the plastic material filling the shaping cavity being and reaching the overflow aperture;
3) the high-pressure nitrogen being imparted through the air pin while part of the melted plastic material near the shaping cavity being hardened, thereby permitting a passage to be formed inside the plastic material to communicate with two ends of a horizontal pipe on the inlet bracket; a part of the plastic material that is squeezed out by the high-pressure nitrogen imparting into the overflow well through the overflow aperture;
4) opening the mold allowing the two sliding device to move toward the exterior of the mold, thereby permitting the two shaping cores on the first sliding device to be drawn from the mold, and permitting the two shaping cores on the second sliding device to be taken out from the mold, so that a roughcast of the inlet bracket inside the shaping cavity could be extracted; and
5) remnants of the material on the roughcast of the inlet bracket and remnants of the hardened plastic material in the overflow well being removed; the hardened remnants on a blocking wall at the lower portion of each upper aperture on the roughcast of the inlet bracket being cut off, and two ends of the horizontal pipe and the outlet passage corresponding to the upper aperture are able to communicate with each other.

The pressure adopted on the high-pressure nitrogen or the high-pressure liquid adopted in step 3) is 150-3000 Bar.

Because the outlet device with the certain-shaped passage is extruded by the high-pressure nitrogen or the high-pressure liquid hardening the melted plastic, such certain-shaped passage having the inlet and outlet gates communicating with each other in the body portion of the outlet device could be formed. Namely, while part of the melted plastic is extruded by the high-pressure nitrogen or the high-pressure liquid and enters the overflow well through the overflow aperture at the end portion, a different means for manufacturing the certain-shaped passage in the plastic could be achieved, thereby attaining an integral product and promoting the bearing strength as well as the using life.

### BRIEF DESCRIPTION OF THE DRAWINGS

FIG. 1 is a schematic view showing a body portion of the outlet device being processed in a first mold;

FIG. 2 is a schematic view showing an outlet portion of the outlet device being air-auxiliarily processed in the first mold;

FIG. 3 is a cross-sectional view showing a roughcast of the body portion of the outlet device;

FIG. 4 is a cross-sectional view showing the body portion of the outlet device;

FIG. 5 is a schematic view showing the body portion of the outlet device being processed in a second mold;

FIG. 6 is a cross-sectional view showing the outlet device of the present invention;

FIG. 7 is a perspective view showing the outlet device of the present invention;

FIG. 8 is a cross-sectional view showing an inlet bracket of the outlet device of the present invention;

FIG. 9 is a schematic view showing a mold before being injected to form the inlet bracket of the outlet device;

FIG. 10 is a schematic view showing the mold during being injected to form the inlet bracket of the outlet device;

FIG. 11 is a schematic view showing the inlet bracket being air-auxiliarily processed; and

FIG. 12 is a perspective view showing the inlet bracket of the outlet device.

### DETAILED DESCRIPTION OF THE PREFERRED EMBODIMENTS

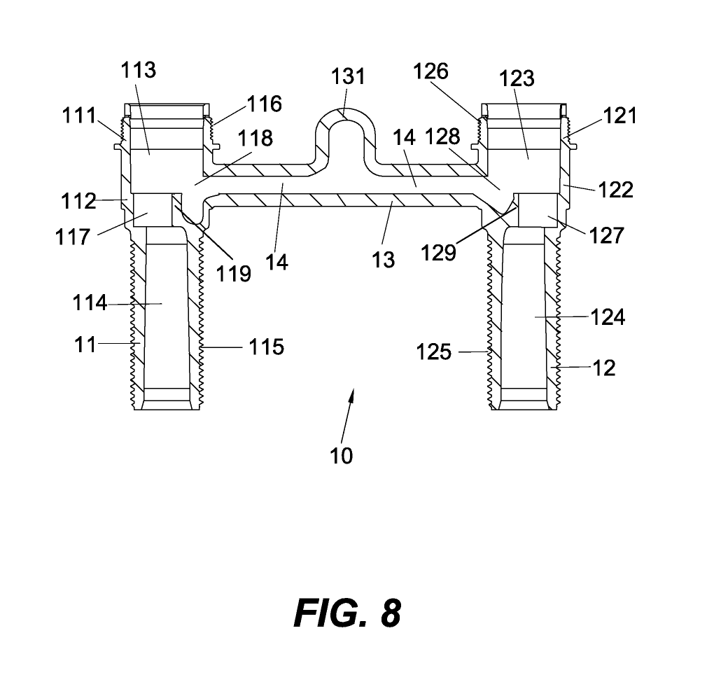

An outlet device of the present invention is shown in FIGS. 7 and 8.

An outlet portion 500 of the outlet device is made of a non-toxic plastic material capable of bearing 100° C. temperature. A body portion 501 is formed curved including a bulky rear portion 502 and a bulky front portion 503. The body portion 501 is wrapped in a case portion 509 adopting a plastic material whose surface could be readily electroplated or sprayed. The surface of the case portion 509 is electroplated or sprayed. Wherein, the non-toxic plastic material capable of bearing 100° C. temperature adopts either the Polyphenylene Oxide (PPO), the Polyphenylene sulfide (PPS), the Polyphthalamide (PPA), or the Polysulfone (PSU); the plastic material that is readily electroplated or sprayed adopts either the Acrylonitrile Butadiene Styrene (ABS), the Polycarbonate (PC), or the alloy made of the ABS and the PC. The non-toxic plastic material capable of bearing 100° C. temperature in the following description adopts the PPA. It is noted that while adopting the PPO, the PPS, or the PSU, the present invention could be likely achieved. The plastic material that is readily electroplated or sprayed in the following description adopts the ABS. It is noted that while adopting the Polycarbonate or the alloy made of the ABS and the PC, the present invention could be likely achieved.

A vertical through hole 504 is defined on the rear portion 502 corresponding to an indentation of the existing horizontal water pipe of the body portion 501, thereby allowing a control pole on a drain valve of a basin to penetrate therethrough. At a lower surface of the rear portion 502 of the body portion 501, two spiral holes 508 are respectively disposed on two installing holes correspondingly at the existing horizontal water pipe, thereby permitting a fastener to penetrate the two installing holes so as to fix the outlet portion 500 on the horizontal water pipe. At the lower surface of the rear portion 502 of the body portion 501, a concave inlet gate 606 is defined correspondingly to a short pipe at the existing horizontal water pipe for linking with the short pipe. At the lower surface of the front portion 503 of the body portion 501, a concave outlet gate 507 including inner threads on its side wall is defined for linking with the existing outlet cover. Further, a curved channel portion 505 inside the body portion 501 is able to communicate with the inlet gate 506 at the rear portion 502 and the outlet gate 507 at the front portion 503.

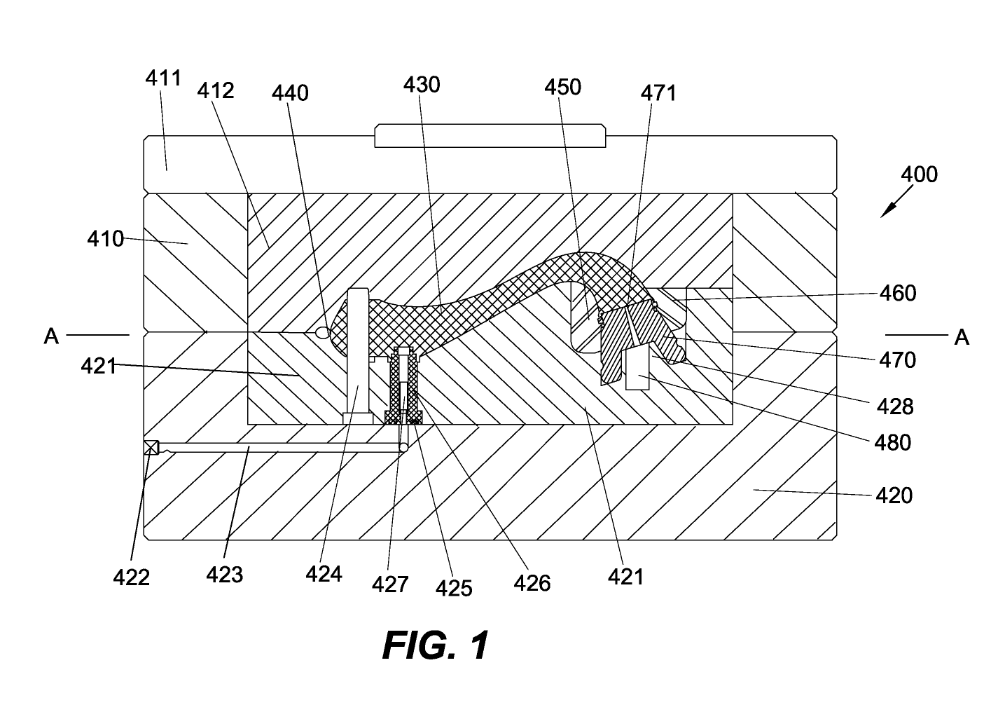

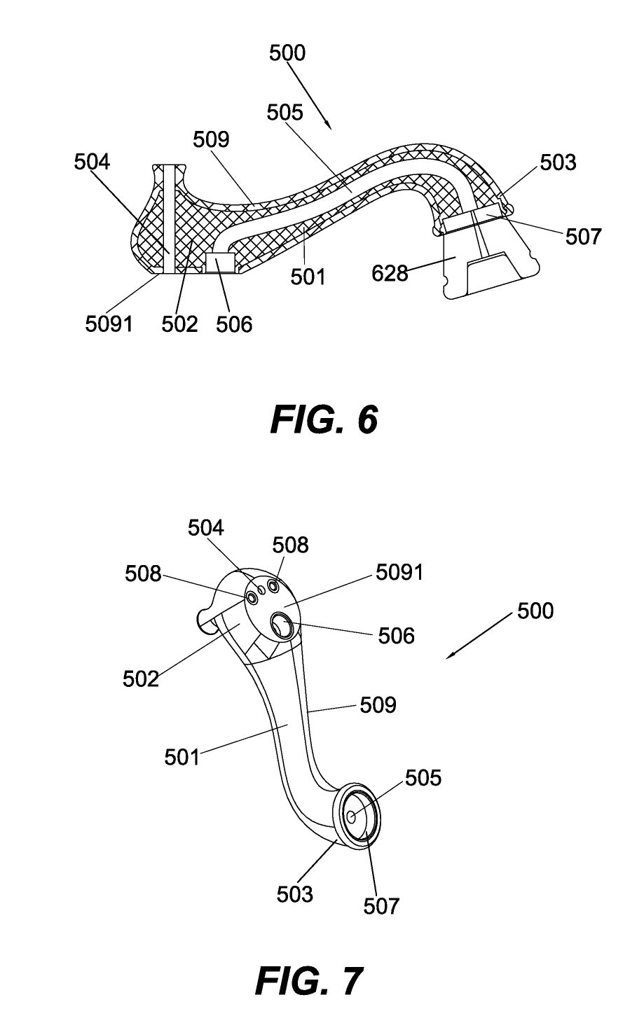

The process for making abovementioned outlet portion of the outlet device is shown from FIGS. 1 to 7:

Referring to FIG. 1, a first fixing mold 410 of a first mold 400 including a clipping device is fixed to a first fixing panel 411. A fixing inlay 412 is installed inside the first fixing mold 410. A first movable inlay 421 is installed inside a first movable mold 420. At the correspondent surfaces of the fixing inlay 412 and the first movable inlay 421, a first shaping cavity 430 of the body portion 501 along with the bulky rear portion 502 and the front portion 503 is disposed. A first pouring hole 440 is disposed at the place where the first shaping cavity 430 corresponds to the rear portion 502 of the body portion 501. An air inlet joint 422 and an air inlet passage 423 are disposed on the first movable mold 420 with respect to the rear portion 502 of the body portion 501. On the first movable inlay 421, a first core shaft 424 is disposed with respect to the through hole 504 of the rear portion 502 of the body portion 501. On the first movable inlay 421, a high pressure sealing ring 425, an air-auxiliary core 426, and an air pin 427 are formed with respect to the inlet gate 506 of the rear portion 502 of the body portion 501. Whereby, the high pressure sealing ring 425 precludes the joint at which the air inlet passage 423 and the air pin 427 meet from the possibility of air leakage. A notch is defined on the first removable inlay 421 with respect to the front portion 503 of the body portion 501 to accommodate a left moving block 450 and a right moving block 460 of a clipping device. At a bottom of the notch, a prominent platen shaped into a conical contour is defined for receiving a spiral core 470 (namely the end portion) with an overflow aperture 471. Further, an overflow well 480 is defined on the prominent platen 428 of the first movably inlay 421.

The spiral core 470 shaped into a conical contour possesses a larger bottom and a smaller top. At the bottom of the spiral core 470, a depression correspondently shaped into a conical contour is defined for engaging with the prominent platen 428 of the first movable inlay 421. An exterior of the spiral core 470 has outer threads, thereby fitting with inner threads defined around the side wall of the outlet gate 507 at the front portion 503 of the body portion 501. A bell-shaped overflow aperture 471 is formed on the top middle of the spiral core 470. Wherein, the overflow aperture 471 providing with a lower section of its widening portion communicates with the aforementioned depression communicates.

Thereby, the spiral core 470 is mounted on the prominent platen 428 of the first movable inlay 421 of the first mold 400. Thereafter, the first movable mold 420 moves toward a first dividing face A for proceeding to a mold closing process. In time of closing the mold, the left moving block 450 and the right moving block 360 move toward a vertical direction with respect to the drawings until the spiral core 470 is tightly clasped. Whereby, the overflow aperture 471 of the spiral core 470 communicates with a place where the first shaping cavity 430 corresponds to the front portion 503 of the body portion 501.

Given an action of injecting the melted PPA (hereinafter the modified nylon) into the first shaping cavity 430 on the fixing inlay 412 and the first movable inlay 421 of the first mold 400 through the first pouring hole 440, the injection should keep working until the melted modified nylon fills the first shaping cavity 430 and reaches the overflow aperture 471 of the spiral core 470.

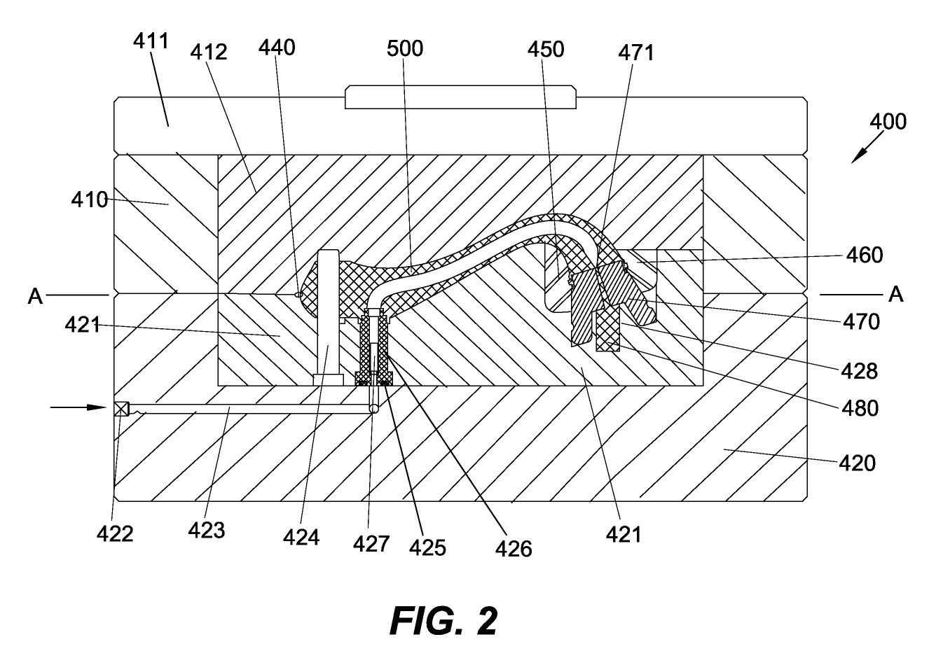

Referring to FIG. 2, in time of hardening part of the melted modified nylon near the wall in the first shaping cavity 430, the injection of high-pressure nitrogen with 150-3000 Bar is imparted to the melted modified nylon in the first shaping cavity 430 through the air inlet joint 422, the air inlet passage 423, and the air pin 427. Thereby, the high-pressure nitrogen extrudes the melted modified nylon in the first shaping cavity 430 to form the curved channel portion 505 that communicates with the inlet gate 506 at the rear portion 502 and the outlet gate 507 at the front portion 503 of the body portion 501. Accordingly, the extruded melted modified nylon by the high-pressure nitrogen enters the overflow well 480 on the prominent platen 428 of the first movable inlay 421 through the overflow aperture 471 on the spiral core 470. As it should be, the nitrogen could be replaced by liquid, for example, the high-pressure liquid could similarly assists in the formation of the channel portion 505 instead of nitrogen.

While the first movable mold 420 moves against the direction with respect to the first dividing face A, the mold could be opened. In time of opening the mold, the left moving block 450 and the right moving block 460 oppositely moves along a vertical direction with respect to the drawings until the spiral core 470 is released. Thereafter, the first movable mold 420 of the first mold 400 is opened to draw the spiral core 470 and the body portion 501.

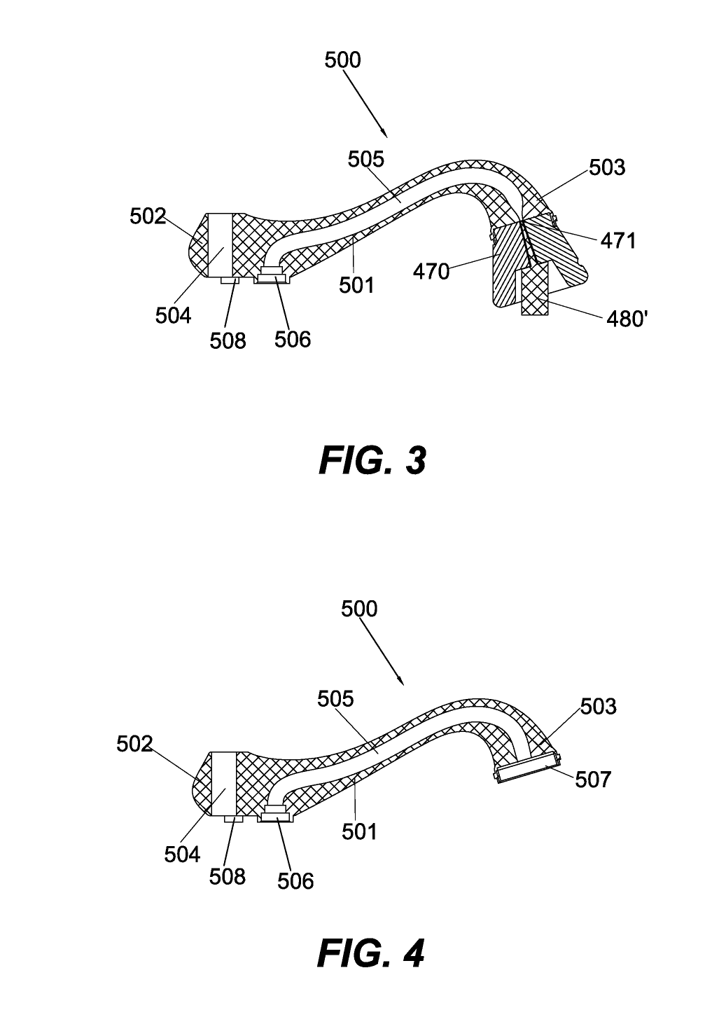

Referring to FIG. 3, the spiral core 470 could be rotatively removed from the front portion 503 of the body portion 501, thereby allowing the hardened modified nylon in the overflow aperture 471 of the spiral core 470 as well as the hardened modified nylon in the overflow well to simultaneously depart from the body portion 501. Thus, a distinct body portion 501 is achieved as shown in FIG. 4.

As it should be, the arrangement of the spiral core 470 could be requisite for meeting the structure as recited in the aforementioned preferred embodiment. In connection with the structure without the spiral arrangement, the overflow aperture could be directly defined on the inlet gate and the outlet gate for linking with the overflow well. After the injection, the redundant material on the gates is removed, and mechanically process is adopted to maintain a guiding angle as well as a bore diameter on the gates.

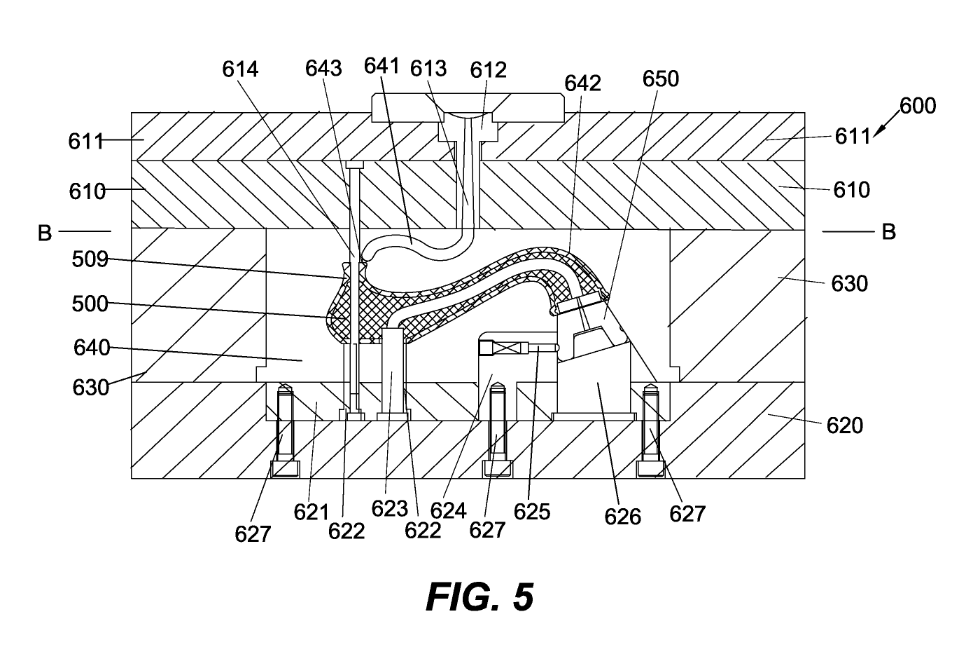

Referring to FIG. 5, a second fixing mold 610 of a second mold 600 is fixed to a second fixing panel 611. A pouring gap 612 is disposed in the second fixing mold 610. On the second fixing mold 610, a second core shaft 614 is disposed with respect to the through hole 504 of the rear portion 502 of the body portion 501. A second movable inlay 621 is disposed in the second movable mold 620. On the second movable inlay 621, four first fixing posts 622 are disposed with respect to the lower surface of the rear portion 502 of the body portion 501. On the second movable inlay 621, a second fixing post 623 is disposed with respect to the inlet gate 506 of the rear portion 502 of the body portion 501. On the second movable inlay 621, an inserting hole is defined with respect to the through hole 504 of the rear portion 502 of the body portion 501 for receiving the free end of the second core shaft 614. At the middle portion of the inlay 621, an auxiliary block 624 is placed with an elastic fixing propelling post 625. On the first movable inlay 421, a fixing platen 626 is mounted with respect to the front portion 503 of the body portion 501. Wherein, on an inclined plane at a top of the fixing platen 626, a prominent platen shaped into a conical contour is disposed for receiving a spiral fixing block 650. The fixing propelling post 625 protrudes toward the prominent platen on the fixing platen 626. Two guiding blocks 630 are respectively disposed at two sides of the first movable mold 420 facing to the surface of the second fixing mold 610. Thereby, the two guiding blocks 630 concurrently restrict the front moving block and the rear moving block 640 to correspondingly move with respect to the vertical direction of the drawings (not shown in FIG. 5). The correspondent surfaces of the front and rear moving blocks 640 respectively installs a main passage 641 and a second shaping cavity 642 with a slightly larger dimension for wrapping the body portion 501. The entrance of the main passage 641 directs to an adhesive inlet hole 613 of the pouring gap 612 on the second fixing mold 610. The second pouring hole 643 of the main passage 641 is defined at a place where the second shaping cavity 642 corresponds to the rear portion 502 of the body portion 501. On the correspondent surface of the front and rear moving blocks 640, a notch and a spiral fixing block 650 are placed. The notch accommodates the fixing platen 626 on the second movable inlay 621 and the protruding part of the auxiliary block 624.

The spiral fixing block 650 is shaped into a conical contour which possesses a larger bottom and a smaller top. At the bottom of the spiral fixing block 650, a depression correspondingly shaped into a conical contour is defined for engaging with the prominent platen of the fixing platen 626 of the second movable inlay 621. An exterior of the spiral fixing block 650 has the outer threads, thereby fitting with inner threads defined around the side wall of the outlet gate 507 at the front portion 503 of the body portion 501.

At the outlet gate 507 on the front portion 503 of the body portion 501, the spiral fixing block 650 is placed, thereby permitting the body portion 501 and the spiral fixing block 650 to be put on the second movable inlay 621 of the second mold 600. On the second movable inlay 621, the upper surface of the four first fixing posts 623 on the second movable inlay 621 respectively prop against the lower surface of the rear portion 502 of the body portion 501. On the second movable inlay 621, the second fixing post 623 inserts into the inlet gate 506 at the rear portion 502 of the body portion 501. On the second movable inlay 621, the prominent platen on the top of the fixing platen 626 inserts into the depression at the bottom of the spiral fixing block 650. The fixing propelling post 625 stretches toward the spiral fixing block 650 for fixing the spiral fixing block 650 on the prominent platen of the fixing platen 626.

Moving the second movable mold 620 toward a second dividing face B contributes to a closing mold process. In time of closing the mold, the front and rear moving blocks 640 accordingly move with respect to the vertical direction of the drawings. Whereby, the body portion 501 is suspended within the second shaping cavity 642 by the body portion 501 and the outer threads on the spiral fixing block 650 accommodated by the second shaping cavity 642, the fixing platen 626 on the second moving inlay 621, and the four first fixing post 622 as well as the second fixing post 623.

The melted ABS is injected into the second shaping cavity 642 by passing from the pouring gap 612 on the second fixing mold 610 of the second mold 600, then to the main passage 641 on the front and rear moving blocks 640, and thence through the second pouring hole 643. While the second shaping cavity 642 is filled up with the melted ABS, a hardening process would be proceeded to accordingly form a case portion 509 out of the body portion 501.

Moving the second movable mold 620 against the dividing face B contributes to an opening mold process. In time of opening the mold, the front moving block separates from the rear moving block 640 with respect to the vertical direction of the drawings. Thereafter, the body portion 501 in the case portion 509 wrapped by the ABS and the spiral fixing block 650 depart from the second shaping cavity 642 of the front and rear moving blocks 640. As a result, the body portion 501 in the case portion 509 wrapped by the ABS and the spiral fixing block 650 are taken out as shown in FIG. 7.

Unscrewing the spiral fixing block 650 allows the separation from the body portion 501 in the case portion 509 wrapped by the ABS. Thereafter, a port on the channel portion 505 on the outlet gate 507 at the front portion 503 of the body portion 501 in the case portion 509 wrapped by the ABS is reamed.

Accordingly, the case portion 509 wrapped by the ABS is further processed by electroplating or spraying; thereby the outlet channel as shown in FIG. 7 is achieved.

Adopting the high-pressure liquid, such as water, achieves the similar manufacturing results on the preferred embodiment as adopting the high-pressure nitrogen, which is herein omitted.

FIGS. 8 to 12 show the method for making the outlet channel while forming like an inlet bracket:

Referring to FIG. 8, the scope from a first upper portion 111 of a first inlet pipe 11 at the left side of the inlet bracket 10 to a first upper aperture 113 of a first middle portion 112 is employed to accommodate a valve body of the first adjusting valve. On the exterior of the top of the first upper portion 111 of the first inlet pipe 11, outer threads 116 are disposed for fixing to a first adjusting valve. On the exterior of the bottom of the first upper portion 111 of the first inlet pipe 11, outer threads 115 are disposed thereon for fixing to a basin. On the bottom of the first upper aperture 113 of the first inlet pipe 11, a first blocking wall 119 is disposed for dividing the lower part of the first upper aperture 113 into a first inlet passage 117 and a first outlet passage 118. The first inlet passage 117 communicates with the inlet gate of the first adjusting valve and a first lower aperture 114 at the lower part of the first inlet pipe 11. The first outlet passage 118 communicates with the outlet gate of the first adjusting valve and the horizontal passage 14 inside the horizontal pipe 13. At the right side of the inlet bracket 10, the section between a second upper portion 121 of a second inlet pipe 12 and a second upper aperture 123 of a second middle portion 122 accommodates the valve body of a second adjusting valve 20. On the exterior of the second upper portion 121 of the second inlet pipe 12, outer threads 126 are disposed thereon for fastening the second adjusting valve 20. On the exterior of the lower part of the second inlet pipe 12, outer threads 125 are disposed thereon for fixing to the basin. At the bottom of the second upper aperture 123 of the second inlet pipe 12, a second blocking wall 129 is disposed for dividing the lower part of the second upper aperture 123 into a second inlet passage 127 and a second outlet passage 128. The second inlet passage 127 communicates with an inlet gate of the second adjusting valve and the second lower aperture 124 at the bottom of the second inlet pipe 12. The second outlet passage 128 communicates with the outlet gate of the second adjusting valve 20 and the horizontal passage 14 inside the horizontal pipe 13. Wherein, the first inlet pipe 11, the second inlet pipe 12, and the horizontal pipe 13 are integrally formed by injecting the plastic material capable of bearing 100° C. temperature, such as PPO, PPS, PPA, or PSU. Afore materials preferably feature non-toxic and great hydrolysising property. The PPO is adopted in the following preferred embodiment. The application adopting the PPS, the PPA, or the PSU similar to the application adopting the PPO is herein omitted.

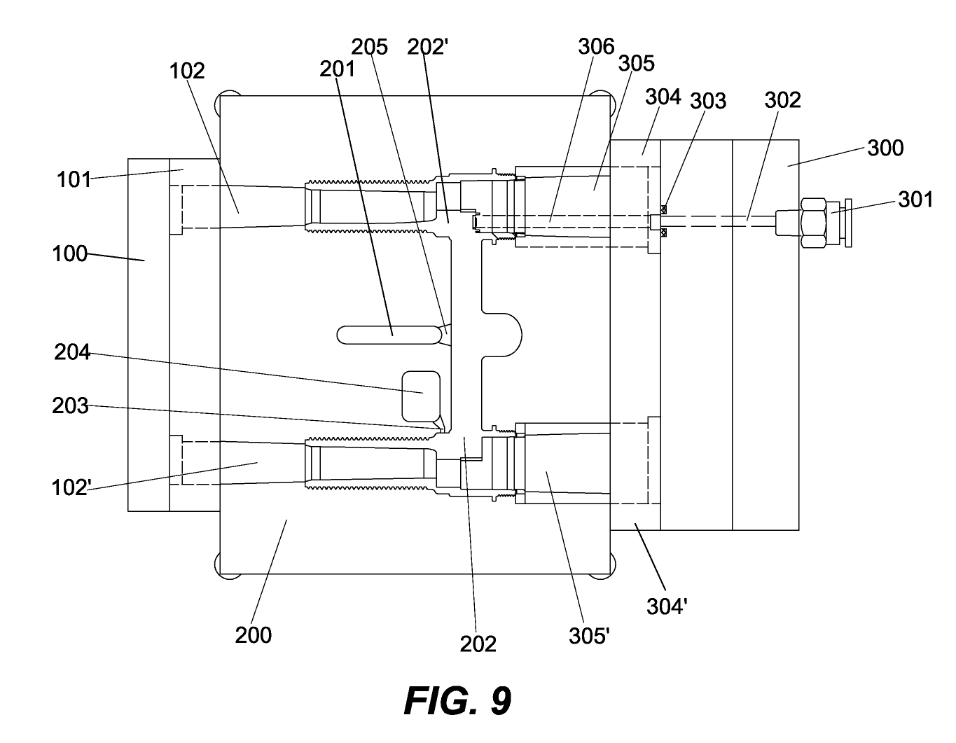

Referring to FIG. 9, a first sliding device 300 with two first shaping cores 305, 305′ is disposed at one correspondent side of the exterior of a parallel injecting mold 200. A second sliding device 100 with two second shaping cores 102, 102′ is disposed at the other correspondent side of the exterior of the parallel injecting mold 200. The second shaping cavity 202 with an H-shaped inlet bracket 10 is correspondingly disposed inside the fixing mold and the movable mold of the injecting mold 200. A main passage 201 and a pouring hole 205 are disposed at an exterior side of a place where the shaping cavity 202 corresponds to the lower side of the middle portion of the horizontal pipe 13 of the inlet bracket 10. An overflow aperture 103 and an overflow well 104 are sequentially disposed at the correspondent position of the right lower side of the second shaping cavity 102 and the horizontal pipe 13 of the inlet bracket 10.

On the first sliding device 300, an air inlet joint 301 and an air inlet passage 302 are disposed. Moreover, at the left surface of the first sliding device 300 as shown in FIG. 4, a high pressure sealing ring 303 is placed around the outlet end of the air inlet passage 302.

A pressing plate 304 disposed on the top left of the first sliding device 300 (e.g. the left side of the inlet bracket 10 as shown in FIG. 8) engages with a first shaping core 305 including an air pin 306. A pressing plate 304′ disposed on the bottom left of the first sliding device 300 (e.g. the right side of the inlet bracket 10 as shown in FIG. 4) engages with a first shaping core 305′. The shape of the two shaping cores 305, 305′ at a first sliding device 300 is formed suited to the shape of the upper apertures 113, 123 in accordance with the inlet bracket 10. The two shaping cores 305, 305′ at the first sliding device 300 arranges respective prominent platens disposed at the outer front side thereof each provided with a shape suitable to the contour of the inlet passages 117, 127 of the lower part of the upper apertures 113, 123 with respect to the inlet bracket 10. Wherein, at the front inner of the left shaping core 305, the air pin 306 penetrating the left shaping core 305 is placed for communicating with the air inlet joint 301 through the air inlet passage 302.

A pressing plate 101 on the second sliding device 100 fixes the left shaping core 102 at the upper right side (e.g. the left side of the inlet bracket 10) and the right shaping core 102′ at the bottom left (e.g. the right side of the inlet bracket 10) as shown in FIG. 8. The shape of the two shaping cores 102, 102′ on the second sliding device 100 is formed suited to the shape of the lower apertures 114, 124 with respect to the bracket inlet 10.

Closing the injecting mold 200 allows the two sliding devices 300, 100 to correspondingly move toward the mold 200. As shown in FIG. 8, the first sliding device 300 moves to the left; thereby the left end thereof is able to prop against the right end of the pressing plate 304. The high pressure sealing ring 303 prevents the air inlet passage 302 and the air pin 306 from leakage. Concurrently, the second sliding device 100 moves rightwards as shown in FIG. 8. The shaping cores 305, 305′ on the first sliding device 300 respectively protrude toward the shaping cavity 202 and the upper aperture 113 (or 123) with respect to the inlet bracket 10. The two shaping cores 102, 102′ on the second sliding device 100 respectively protrude toward the shaping cavity 202 and the lower aperture 114 (or 124) with respect to the inlet bracket 10. The front end of the front prominent platen of the two shaping cores 305, 305′ on the first sliding device 300 respectively prop against the front end of the corresponding shaping cores 102, 102′ on the second sliding device 100.

Referring to FIG. 9, closing the injecting mold 200 allows the melted PPO to be injected into the shaping cavity 202 of the mold 200 through the pouring hole 205 until the melted PPO fills the shaping cavity 202 and reaches the overflow aperture 203.

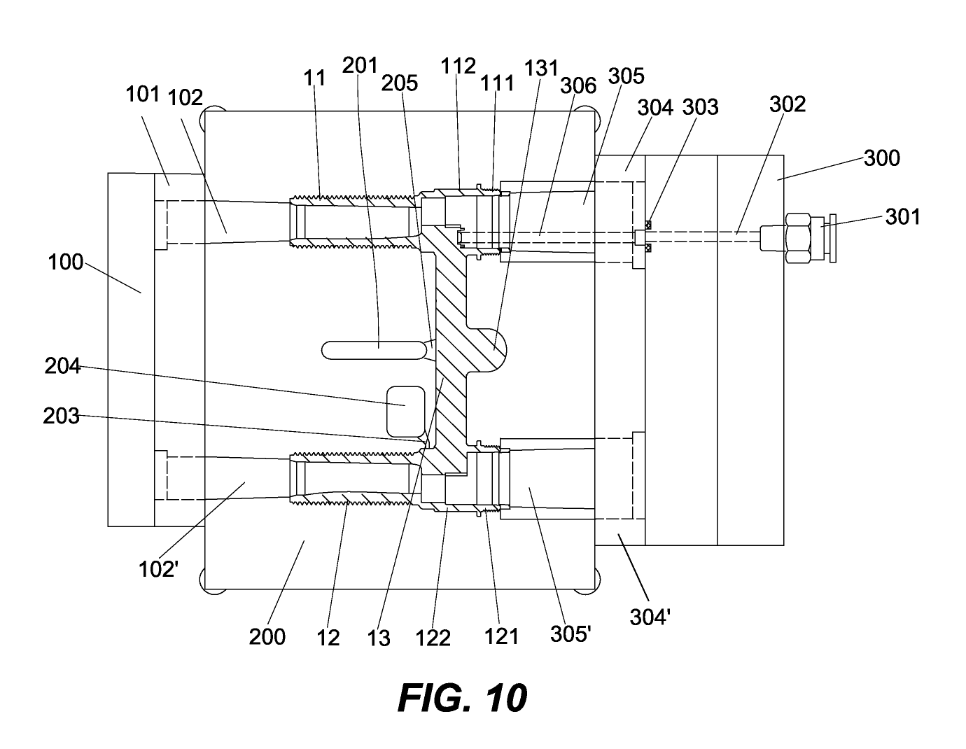

Referring to FIG. 10, the high-pressure nitrogen with 150-3000 Bar is imparted on the melted PPO in the shaping cavity 202 by entering from the air inlet joint 301, going to the air inlet passage 302, and thence passing through the air pin 306 on the right shaping core 305 while the melted PPO in the right shaping cavity 202 and the left shaping cavity 202′ of the injecting mold 200 having a part thereof near the wall of the shaping cavity of the body portion is hardened. The inner of the melted PPO that is extruded by the high-pressure nitrogen unstops the horizontal passages 14 at two ends of the horizontal pipe 13 on the inlet bracket 10. Part of afore extruded PPO further enters the overflow well 204 through the overflow aperture 203 for being hardened within the overflow aperture 203 and the overflow well 204, so that the PPO could be transformed into the PPO remnants 15, 16. The overflow aperture 203 controls the pressure imparted to the melted PPO in the shaping cavity 202 while injecting the high-pressure nitrogen, thereby ensuring the close outer threads 116, 115, 126, 125 to be formed at the exterior of the first inlet pipe 11 and the second inlet pipe 12 on the inlet bracket 10.

After the roughcast of the inlet bracket 10 in the shaping cavity 202 inside the parallel injecting mold 200 is cooled and hardened, the injecting mold 200 is opened. Whereby, the first sliding device 300 moves rightwards, and the two shaping cores 305, 205′ on the first sliding device 300 depart from the injecting mold 200. Concurrently, the second sliding device 100 moves leftwards, and the two shaping cores 102, 102′ depart from the injecting mold 200. Thereafter, the roughcast of the inlet bracket 10 in the shaping cavity 202 is taken out.

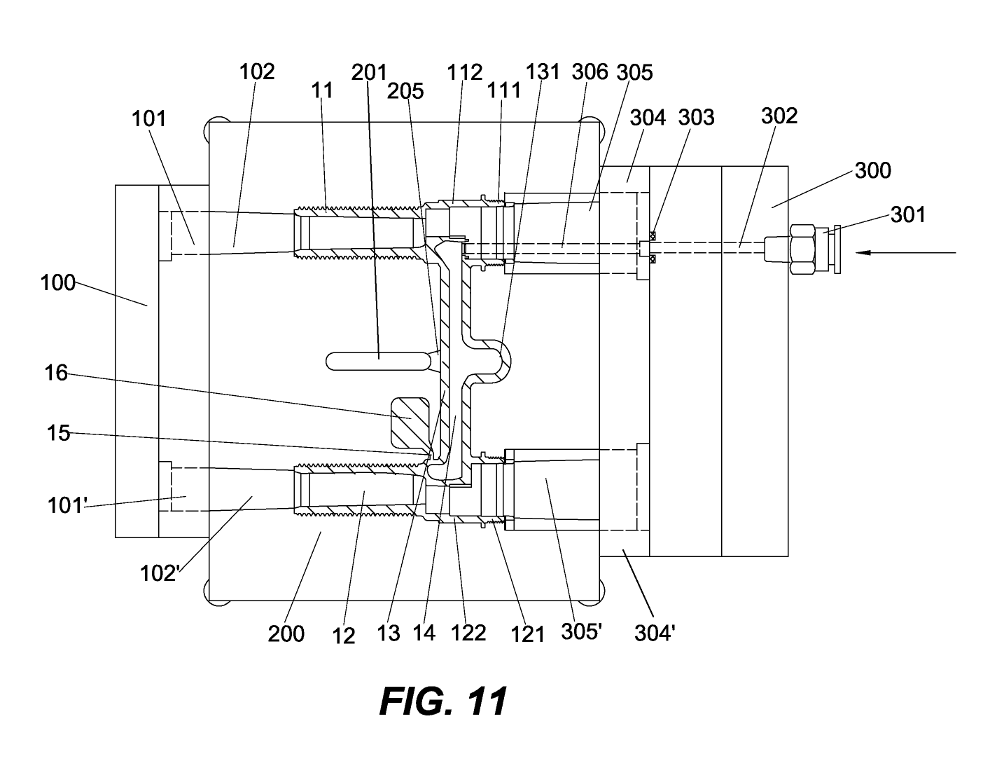

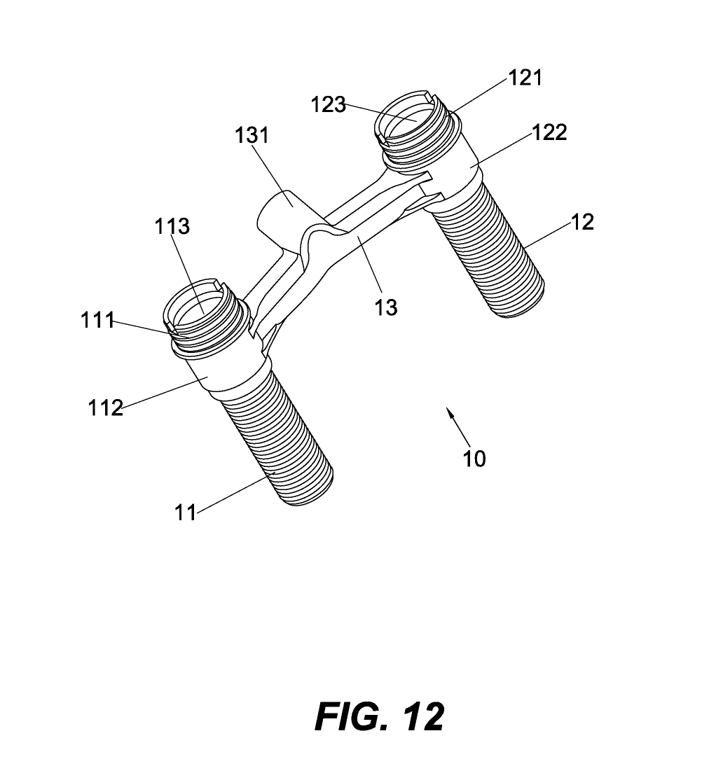

Referring to FIG. 11, the hardened PPO remnants 15, 16 in the overflow aperture 203 and the overflow well 204 are removed from the roughcast of the inlet bracket 10. A drill or a mill is applied to cut off the hardened PPO remnants 15 above the lower first blocking wall 119 of the upper aperture 113 at the left side of the roughcast of the inlet bracket 10. Thereby, the left end of the horizontal pipe 13 and the first outlet passage 118 of the upper aperture 113 are intercommunicated. A drill or a mill is applied to cut off the hardened PPO remnants 15 above the lower second blocking wall 129 of the upper aperture 123 at the right side of the roughcast of the inlet bracket 10. Thereby, the right end of the horizontal pipe 13 and the second outlet passage 128 of the upper aperture 123 are intercommunicated. As a result, the finished product of the inlet bracket 10 is achieved as shown in FIG. 12.

I claim:

1. Method for making an outlet channel comprising steps of:
1) a shaping cavity being formed in a first mold corresponding to an surface of a body portion of an outlet device; an air spout being disposed in accordance with an inlet gate or an outlet gate of said outlet device; an overflow aperture being disposed corresponding to said inlet or outlet gates, thereby connecting to an overflow well;
2) a non-toxic melted plastic material capable of bearing 100° C. temperature keeping being injected into said shaping cavity of said first mold until said plastic material filling said shaping cavity and reaching said overflow aperture of an end portion;
3) the high-pressure nitrogen or the high-pressure liquid being imparted through said air spout while part of said melted plastic material near said shaping cavity being hardened, thereby permitting a passage with a certain shape to be formed inside said plastic material to communicate with said inlet and outlet gates of said body portion of said outlet device; a part of said plastic material that is extruded by said high-pressure nitrogen or said high-pressure liquid imparting into said overflow well through said overflow aperture on said end portion;
4) said outlet device with said end portion being drawn after the mechanism being cooled and said first mold being opened; and
5) said outlet device with said certain-shaped passage formed thereby being achieved after removing said end portion from said outlet gate of said body portion.

2. The method as claimed in claim 1, wherein, a spiral fixing block installed at a front portion of said body portion of said outlet device after the step 5) is further mounted into a shaping cavity of a second mold, thereby employing a fixing platen and a fixing post to suspend said body portion of said outlet device in said shaping cavity;
6) a melted plastic material that could be readily electroplated or sprayed keeps being injected into said shaping cavity of said second mold until said plastic material fills said shaping cavity, thereby forming a hardened case portion out of said body portion;
7) said body portion wrapped in said plastic material and said spiral fixing block are drawn from said shaping cavity after said second mold is opened;
8) said spiral fixing block and said body portion wrapped in said plastic material are separated so as to ream a passage port on said outlet gate at said front portion of said body portion; and
9) the surface of said case portion of said body portion of said outlet device wrapped in said electroplated or sprayed material is further electroplated or sprayed.

3. The method as claimed in claim 1, wherein, said pressure adopted on said high-pressure nitrogen or said high-pressure liquid is 150-3000 Bar.

4. Method for making an outlet channel including an outlet device adopting an inlet bracket comprising steps of:
1) an H-shaped shaping cavity for said inlet bracket being disposed inside a mold; an overflow aperture and an overflow well being sequentially disposed out of said shaping cavity; each of two sliding devices including a shaping core being respectively disposed at two correspondent sides of the exterior of said mold; the shape of said two shaping cores at a first sliding device being formed into a shape suitable to the contour of an upper aperture in accordance with said inlet bracket; the exterior at a front portion of said two shaping cores respectively forming a prominent platen suitable to the contour of an inlet passage at a lower portion of said upper aperture in accordance with said inlet bracket; an inner front of one of said shaping cores installing an air pin that penetrates said shaping core; the shape of said two shaping cores of a second sliding device being formed into a shape suitable to the contour of a lower aperture in accordance with said inlet bracket; thereby, closing said mold allowing said two sliding devices to correspondingly move toward said mold, thence permitting said two shaping cores respectively to protrude toward a position corresponding to said upper aperture in accordance with said inlet bracket on said shaping cavity; said two shaping cores on said second sliding device respectively protruding toward a position corresponding to said lower aperture in accordance with said inlet bracket on said shaping cavity; a front face of said prominent platen at said front portion of said two shaping cores on said first sliding device respectively propping against a front face of said correspondent shaping core on said second sliding device;
2) a non-toxic melted plastic material capable of bearing 100° C. temperature keeping being injected into said shaping cavity of said mold until said plastic material filling said shaping cavity and reaching said overflow aperture;
3) the high-pressure nitrogen or the high-pressure liquid being imparted through said air pin while part of said melted plastic material near said shaping cavity being hardened, thereby permitting a passage to be formed inside said plastic material to communicate with two ends of a horizontal pipe on said inlet bracket; a part of said plastic material that is squeezed out by said high-pressure nitrogen or said high-pressure liquid imparting into said overflow well through said overflow aperture;
4) opening said mold allowing said two sliding device to move toward the exterior of said mold, thereby permitting said two shaping cores on said first sliding device to be drawn from said mold, and permitting said two shaping cores on said second sliding device to be taken out from said mold, so that a roughcast of said inlet bracket inside said shaping cavity could be extracted; and
5) remnants of said material on said roughcast of said inlet bracket and remnants of said hardened plastic material in said overflow well being removed; the hardened remnants on a blocking wall at said lower portion of each upper aperture on said roughcast of said inlet bracket being cut off, and two ends of said horizontal pipe and said outlet passage corresponding to said upper aperture being able to communicate with each other.

5. The method as claimed in claim 4, wherein, said pressure adopted on said high-pressure nitrogen or said high-pressure liquid is 150-3000 Bar.
